(19) United States
(12) Patent Application Publication
(10) Pub. No.: US 2006/0153765 A1
(43) Pub. Date: Jul. 13, 2006

(54) Method for preparing catalysts for heterogeneous catalysis by multiple-phase impregnation, catalysts and use of said catalysts

(76) Inventors: Cuong Pham-Huu, Severne (FR); Nicolas Keller, Strasbourg (FR); Marc-Jacques Ledoux, Strasbourg (FR); Jean-Mario Nhut, Strasbourg (FR); Laurie Pesant, Strasbourg (FR); Claude Estournes, Schiltigheim (FR)

Correspondence Address: CONNOLLY BOVE LODGE & HUTZ LLP, SUITE 800, 1990 M STREET NW, WASHINGTON, DC, 20036-3425, US

(21) Appl. No.: 10/520,524

(22) PCT Filed: Jul. 7, 2003
(86) PCT No.: PCT/FR03/02101

§ 371 Date: Oct. 28, 2005

(30) Foreign Application Priority Data
Jul. 9, 2002 (FR) 02/08635

(51) Int. Cl. C01B 31/36; B01J 27/224

(52) U.S. Cl. 423/345; 502/178

(57) ABSTRACT

The invention concerns a method for so-called two-phase impregnation of a β-SiC support with high specific surface area, said method comprising at least the following steps: (a) a first impregnating at least once said support with a polar agent A, (b) a second impregnating which consists in impregnating at least once said support with at least an agent B less polar than agent A. Said method enables the production of novel catalysts for heterogeneous catalysis.

### FIELD OF THE INVENTION

The invention relates to the field of β-SiC based catalysts for heterogeneous catalysis and particularly two-phase impregnation of supports with a large specific surface area with active phase precursors to form such a catalyst.

### STATE OF THE ART

Catalysts used at the present time in the chemical or petrochemical industry, or for depollution of exhaust gases of vehicles with internal combustion engines, are essentially in the form of pellets, extruded materials, cylinders or monoliths, simply to mention a few of the most frequently used forms. These materials act as an active phase support or as the said active phase precursor, in the latter case an active phase being deposited on the said support to form the catalyst. This active phase is frequently composed of metals or metal oxides.

The active phase is deposited on supports used at the present time using an impregnation step during which the solution containing an active phase precursor is deposited uniformly over the entire surface of the support. This precursor is then usually subjected to an activation treatment. The precursor in question may be a salt or an organo-metallic compound.

It is impossible to control the precise position of the active phase in the catalyst with the conventional impregnation process (for example described in the “Heterogeneous catalysis” article by D. Cornet published in the “Chemical engineering and process” treatise in the “Techniques de l'Ingénieur (Engineering techniques)” collection, volume J1, article J1250, p. 23/24 (September 1992)).

According to the state of the art, the precursor solution may be an aqueous solution or an organic solution. For example, it is known that SiO₂, Al₂O₃, α-SiC (polytype 6H) or β-SiC (cubic) supports can be impregnated with a solution of palladium bis-acetyl-acetonate (II), Pd(C₅H₇O₂)₂ in toluene (see article by C. Méthivier et al., “Pd/SiC Catalysts—Characterisation and Catalytic Activity for the Methane Total Oxidation”, Journal of Catalysis 173, p. 374-382 (1998)). Patent application WO 99/20390 (Centre National de la Recherche Scientifique—National Scientific Research Centre) describes the impregnation of a non-porous Si₃N₄ powder with the specific surface area BET equal to 8.8 m²/g by a solution of palladium bis-acetyl-acetonate (II) in toluene, and the fabrication, characterisation and use of the catalyst thus obtained.

Organic compounds of metal in the pure or diluted state have also been used, when these compounds are in the liquid state. This is the case of the (C₃H₇Sn)₂O compound (see D. Roth et al., “Combustion of methane at low temperature over Pd and Pt catalysts supported on Al₂O₃, SnO₂ and Al₂O₃-grafted SnO₂”, published in the Topics in Catalysis review, vol. 16/17, No. 1-4, p. 77-82 (2001)). This same compound was also used with Si₃N₄ supports in the form of powder with a BET surface area of 9 m²/g (see article by C. Méthivier et al., “Pd/Si₃N₄ catalysts: preparation, characterisation and catalytic activity for the methane oxidation”, Applied Catalysis A: general, vol 182, p. 337-344 (1999)).

The article “Exhaust gas catalysts for heavy-duty applications: influence of the Pd particle size and particle size distribution on the combustion of natural gas and biogas” by E. Pocoroba et al., published in the Topics in Catalysis journal, vol 16/17, No.1-4, p. 407-412 (2001) describes the impregnation of cordierite (γ-Al₂O₃) monoliths with an aqueous solution of Pd(NO₃)₂ or with a microemulsion, in other words a colloidal solution containing nanometric palladium particles, obtained by reduction using an aqueous solution of hydrazine, of an emulsion formed from an aqueous solution of Pd(NO₃)₂ and a non-ionic surfactant.

None of these techniques can be used to control the position of the active phase with respect to the support, and particularly with respect to the porosity characteristics of the support. Furthermore, if two or several metals are deposited to form one or several active phases within the same catalyst, known techniques cannot be used to control the position of the different active phases with respect to each other.

Known techniques enabling control of the position of the active phase with respect to the support are not frequently used at the moment. Existing methods have a fairly limited performance, since they are used either to deposit the active phase exclusively on the external face of the support (called egg-shell impregnation, the support surface being covered by a thick active phase layer), or to confine the active phase inside the support matrix (see FIG. 1). These methods are described in the book “Fundamentals of Industrial Catalytic Processes” by F. J. Farrauto and C. H. Bartholomew (published by Chapman & Hall), particularly on pages 89 to 93. The two-phase impregnation method is also known.

In the first case (egg-shell impregnation, see FIG. 1(a)), a large active phase concentration is necessary in order to give good coverage of the outer surface of the support. The result is embrittlement of the material causing a sudden drop in the mechanical strength of the active phase due to sintering and attrition problems. This causes a gradual loss of the active phase as a function of time. Furthermore, in these preparations, the active phase position can only be controlled with respect to the macroscopic matrix and not with respect to the porosity of the said support.

In the second case (internal impregnation, see FIG. 1(b)), the particular position of the active phase within the support matrix avoids attrition problems caused by friction between different supports during operation phases of the said material. However, this position imposes that reagents and reaction products in the gas and liquid phases diffuse through the porous matrix of the support before reaching the active phase or going out of the catalyst pellet. The result is lower efficiency, particularly in two situations: especially when the transfer velocity of the reagents is high, and when the global reaction is subject to parallel or successive reactions leading to the formation of unwanted products.

It is known that during reactions between a gas phase containing the reagents to be transformed and a solid catalyst, the position of the active phase with respect to the porosity of the catalyst is a very important factor that acts both on the conversion rate and the selectivity of the reaction. When the active phase is located inside the porosity of the support, the conversion and selectivity of the reaction may be influenced essentially by two factors:
(i) diffusion of gas phase reagents to active sites: as the depth of the active phase in the pores network increases, the diffusion of reagents in the active phase to active sites limits the reaction rate and causes a drop in the conversion compared with the conversion expected in the lack of any diffusion phenomena. This phenomenon is accentuated when the reagents transfer velocity is high.
(ii) Back-diffusion of products from active sites towards the outside of the support is also very sensitive to the position of the said active sites. As the porosity becomes more complex, the number of secondary reactions that take place during back-diffusion of products to the outer surface increases, thus significantly reducing the global selectivity of the reaction.

The problem that this invention is intended to solve is to present a new β-SiC catalyst comprising a support and at least one active phase with controlled positioning, in which the influence of phenomena consisting of diffusion of reagents towards active sites and back-diffusion of products towards the surface of the catalyst on the dynamics of the reaction taking place with the assistance of the said catalyst is not as high as in the case with known catalysts.

### SUBJECT MATTER OF THE INVENTION

The first subject matter of this invention is a process for impregnation of a β-SiC support with a specific surface area, determined by the BET nitrogen adsorption method at the temperature of liquid nitrogen according to standard NF X 11-621, equal to at least 1 m²/g and comprising macropores with a size between 0.05 and 10 μm, and optionally also mesopores with a size between 4 and 40 nm, the said process comprising at least the following steps:
(a) a first impregnation step during which the said support is impregnated at least once by a polar agent A,
(b) a second impregnation step during which the said support is impregnated at least once by an agent B less polar than agent A,
   and in which process at least one agent B among the said agents A and B comprises at least one active phase precursor.

The active phase precursor, preferably a metallic compound, may be selected from the group composed of the Fe, Ni, Co, Cu, Pt, Pd, Rh, Ru and Ir elements. The said precursor may advantageously be chosen among organo-metallic compounds and salts of the said elements.

Yet another subject matter of this invention is the catalyst that could be obtained by the said catalyst preparation process.

Yet another subject matter of this invention is use of the catalyst obtained by the said process as a catalyst for chemical reactions such as oxidation of methane or other hydrocarbons, or oxidation of carbon monoxide.

### DESCRIPTION OF THE FIGURES

FIG. 1 diagrammatically shows two profiles of the macroscopic position of the active phase with respect to the support in catalysts according to the state of the art.
(a) egg-shell deposit; (b) deposit at centre; (c) uniform deposit.

FIG. 2 diagrammatically shows the position of the active phase in a catalyst.
(a) Catalyst according to the state of the art impregnated by the conventional method. The active phase is located in hydrophilic areas (inside pores).
(b) Catalyst according to the invention, comprising a support with hydrophilic/hydrophobic properties, impregnated by the two-phase impregnation method. The active phase is located on hydrophobic areas (outside the pores).

FIG. 3 shows the conversion of CH₄ into CO₂ as a function of the reaction temperature for a gas hourly space velocity of 15 000 h⁻¹ on Pd(0)/β-SiC catalysts prepared by conventional impregnation (black dots) and two-phase impregnation (hollow circles).

FIG. 4 shows an enlargement of FIG. 3, showing half-conversion temperatures.

FIG. 5 shows the conversion of CH4 into CO₂ as a function of the reaction temperature for a gas hourly space velocity of 40 000 h⁻¹ on Pd(0)/β-SiC catalysts prepared by conventional impregnation (black dots) and two-phase impregnation (hollow circles).

FIG. 6 shows an enlargement of FIG. 5, showing half-conversion temperatures.

FIG. 7 shows the conversion of CH₄ into CO₂ as a function of the reaction temperature for a gas hourly space velocity of 200 000 h⁻¹ on Pd(0)/β-SiC catalysts prepared by conventional impregnation (black dots) and two-phase impregnation (hollow circles).

FIG. 8 shows an enlargement of FIG. 7, showing half-conversion temperatures.

FIG. 9 shows the distribution of macropores by size in two β-SiC supports suitable for implementation of the invention.

### DESCRIPTION OF THE INVENTION

In the context of this invention, the problem that arises is solved using the impregnation method called “two-phase impregnation”. This impregnation method, the principle of which is described in documents U.S. Pat. No. 5,700,753, EP 133 108 A1, EP 623 387 A, WO 00/67902 and WO 00/29107, consists of making a judicious choice of the agent to selectively saturate either hydrophilic areas or hydrophobic areas of the support so as to be able to selectively deposit and thus locate the precursor compound forming the active phase, either on hydrophobic areas or on hydrophilic areas depending on the target reaction. The method thus enables microscopic control of the position of the active phase with respect to the support matrix, rather than macroscopic control as is done conventionally as described above.

For the purposes of this description, a “polar agent” means a molecule with a permanent dipole moment. An agent X is less polar than an agent Y if the permanent dipole moment of agent X is greater than the permanent dipole moment of agent Y. For example, water is a polar agent, and toluene is a less polar agent than water.

This invention is applicable to catalysts made on a β-SiC support with two distinct surface functions (hydrophobic and hydrophilic). Any β-SiC catalyst support with these two functions can be suitable, provided that its porosity and its specific surface area determined by the BET nitrogen and adsorption method are sufficient, in other words at least 1 m²/g and preferably at least 2 m²/g.

Advantageously, the support has a specific surface area of between 1 and 100 m²/g. Supports with a specific surface area of more than 10 m²/g are preferred, and more than 20 m²/g is even better. This specific surface area is due to the presence of pores. A distinction is made between three types of pores: micropores with an average size typically smaller than 4 nm, mesopores with a size typically between 4 and 50 nm, and macropores that can form networks for which the typical diameter is more than 50 nm. In the context of this invention, supports for which the total porosity measured by nitrogen adsorption is essentially composed of mesopores between 4 and 40 nm and a macroporous system with an average diameter of between 0.05 and 100 μm are preferred, and values of 0.05 and 10 μm are better, and 0.05 and 1 μm are even better. The distribution of pores by size is demonstrated by penetration of mercury. The pores may also be observed directly by scanning electron microscopy. Advantageously, the distribution of macropores by size is between 0.06 and 0.4 μm, and even preferably is between 0.06 and 0.2 μm.

In one preferred embodiment of this invention, a β-SiC silicon carbide is used in the form of extruded materials or balls prepared using any of the synthesis techniques described in patent applications EP 0 313 480 A, EP 0 440 569 A, EP 0511 919 A, EP 0 543 751 A and EP 543 752 A.

The surface of silicon carbide (β-SiC) prepared according to one of the references mentioned above is composed of two types of areas with different reactive natures. A first type of area is hydrophobic and forms the outer surface of the solid and lines the inner surface of the macropores. These areas are composed essentially of planes with low Miller indexes, that are stable and have low reactivity with oxygen in the air. In the presence of organic solvents, wetting takes place essentially in these hydrophobic areas. The second type of area is hydrophilic and relates essentially to internal walls of mesopores in the solid. These areas are composed of atomic planes with high Miller indexes and consequently are rich in structure defects. The presence of defects with high reactivity with regard to oxidation and adsorption phenomena involving external elements, causes the incorporation of a high proportion of oxygen on the surface of pore internal walls. In the presence of aqueous solvents, these solvents preferentially cover these hydrophilic areas. Therefore, the use of this bi-impregnation technique can neutralise these mesopores for the deposit of an active phase in the macropores, or can deposit an active phase in the mesopores first, and then another active phase in the macropores of β-SiC. The first objective may be achieved in one particular embodiment by applying a heat treatment to the support under an inert gas, which has the effect of reducing the mesoporosity.

The following contains a detailed description of the two-phase impregnation mode. The support as described above is impregnated as described below, by making use of its hydrophobic and hydrophilic properties so that the position of the active phase with respect to the pores network can be modified and controlled so as to improve access of reagents to active sites and maintain the reaction efficiency, while reducing the residence time of reagents and the porosity of the support.

The two-phase impregnation mode consists of two successive impregnation steps, the first using a polar agent (such as water), and the second using an agent B that is less polar than agent A, and particularly an apolar organic liquid. In both steps, the agents may advantageously be liquids. The said liquids may be solutions, and in particular may contain metallic salts.

In one preferred embodiment, the first impregnation step consists of wetting the β-SiC support with water (preferably demineralised or distilled water). In one particularly advantageous embodiment of the invention, the water volume is equal to or slightly greater than the total porous volume of the solid. This operation completely saturates the hydrophilic areas of the surface of the solid that are essentially located inside the pores of the material. Water thus remains trapped inside the pores leaving the hydrophobic areas that form the outer surface of the solid free.

In another embodiment, a polar liquid containing one or several soluble compounds is used during this first impregnation step. The said soluble compound may be a metallic compound. The said metallic compound may act as the active phase or active phase precursor.

After this first impregnation step by the polar liquid, the surface of the impregnated solid is dried in order to eliminate the humidity of the outer surface of the body, while keeping liquid in the pores. For example, a temperature of 50° C. at normal pressure would be suitable for an aqueous liquid: the precise conditions (temperature and duration) for a given support may easily be determined using simple routine experiments.

In a second impregnation step, at least one active phase precursor is deposited on the solid, preferably in an essentially apolar organic solution. An “active phase precursor” means a compound of a metal, typically a salt of a metal or an organo-metallic compound which, after a calcination treatment possibly followed by other processing such as reduction, forms the active phase of the catalyst. It is desirable to select the solvent such that the affinity of the organic solvent with hydrophobic areas enables perfect wetting of these areas, while the inside of the pores remains inaccessible due to the presence of the previously impregnated water. Evaporation of water trapped in the pores of the solid during drying is strongly inhibited due to the strong interactions between the inner surface of the pores in the solid (hydrophilic) and water trapped in these pores, and consequently the pre-impregnated water forms a protection barrier for hydrophilic areas. In some cases, pure liquid organo-metallic compounds can be used as the active phase precursor.

In a first activation step, the impregnated support is then dried, for example under air at ambient temperature and then at a temperature advantageously between 100° C. and 200° C., in a drying oven in order to vaporise the organic solvent. The dried solid is calcined under air at a temperature typically between 200° C. and 500° C. and preferably between 300° C. and 400° C. for a period that depends on the load in the furnace, the characteristics of the solvent and of the support, in order to decompose the active phase precursor into its corresponding metallic oxide.

The calcined solid can be used as is, as a catalyst. Depending on its future use, a second optional activation step may also be carried out on it, which is advantageously a treatment under a reactive gas and preferably a reduction. During this second activation step, the oxide may be reduced under a hydrogen flow H₂ to obtain the corresponding metal, or treated with other gases in order to obtain the desired active phase. The active phase thus obtained is located essentially on surfaces composed of hydrophobic support areas, i.e. surfaces external to the pores.

Taking account of the specific position of hydrophobic and hydrophilic areas in the silicon carbide based support, namely outside the pores of the support for hydrophobic areas and inside the pores for hydrophilic areas, the position of the active phase may be shown diagrammatically with respect to the support porosity as shown in FIG. 2.

The following describes the main characteristics of the catalyst obtained, and its application fields. In the context of this invention, the active phase may be composed of any metal with a soluble salt in a slightly polar solvent, or a sufficiently stable organo-metallic compound. These metals include particularly Co, Ni, Fe, Cu, Pt, Pd, Rh, Ru and Ir. The concentration of the said active phase may be within a relatively wide range of about 10 ppm (parts per million with respect to the mass), up to several tens of percent (with respect to the mass) depending on the target reaction. Advantageously, it is between 0.1 and 5% with respect to the mass of the catalyst.

Another variant taking advantage of the benefit of this impregnation method concerns deposition of two different compounds on the same support, using a solvent with an appropriate polarity for each thus enabling precise control over their positions. The two-phase impregnation method described may also be applied to successively deposit two compounds, each forming an active phase, used separately due to their different and particular catalytic properties, but located on the same support.

The catalyst thus prepared may be used under different conditions and in different reaction media. More particularly, it may be used for reactions with a very high reagent transfer velocity, i.e. for depollution of exhaust gases from internal combustion engines, or for reactions in which the global selectivity can be affected by secondary reactions between the products and one of the excess reagents during diffusion of products from active sites to the outer surface of the support.

This invention has many advantages:

Firstly, the improved access of reagents in the gas phase or liquid phase to active sites enables a significant improvement in the global efficiency of the reaction. When the active phase is deposited directly on the outer surface of the support or in a macroporosity, access of gas or liquid phase reagents to active sites may be considerably improved; this increases the reaction efficiency.

The extremely short residence time between the active phase and the reagents and the reaction products can thus significantly reduce the formation of secondary products. When one of the reagents is in excess and can once again react with one of the products formed during the reaction, the duration of migration of products through the support porosity to reach the gas or liquid phase, or more generally escape from the catalyst pellet, can be a very important factor in the global selectivity of the reaction.

In addition, the fact of locating the active phase on the hydrophobic area has an undoubted advantage when water is one of the reaction products. Water may induce undesirable modifications to the active phase due to its oxidising nature. When the active phase is located on the hydrophilic areas, the water formed can be adsorbed on active sites of the catalyst and oxidise it, while water adsorption is avoided when the active phase is located on the hydrophobic areas. This advantage is also significant when the reaction takes place in the presence of water or any other solvent with a strong interaction with hydrophilic areas and with oxidising properties in the reaction medium.

And finally, the deposition method according to the invention also considerably reduces the necessary content of the active phase with respect to the content used in eggshell impregnations. Consequently, the loss of the active phase that can occur either by sintering or by attrition during impregnation or more generally during the catalyst preparation or activation phases and during the catalytic test, is considerably reduced; this increases the life time of the catalyst.

Catalysts prepared within the framework of this invention combine the advantages acquired on conventional macroscopic supports and the advantages of better access of reagents to active sites and better evacuation of products. They thus enable a non-negligible improvement in the efficiency of the different reactions while maintaining maximum dispersion of the active phase to not reduce the global efficiency of the reaction. With the preferred execution method using supports made of extruded materials, balls or pellets of β-SiC, the specific advantages associated with this type of support are also available.

The catalyst according to the invention may be used in various fields, such as the chemical or petrochemical industry. For example, it can catalyse the oxidation of methane or oxidation of carbon monoxide. It can also be used in exhaust gas depollution reactions for internal combustion engines (particularly engines running on liquid fuel such as gasoline or diesel), for which it improves the efficiency due to very short contact time and very good access of reagents to active sites of the catalyst.

The following series of non-limitative examples illustrate the invention and are complementary to the description given above.

### EXAMPLES

### Example 1

### Preparation of the Catalyst by Two-Phase Impregnation

This example gives a detailed illustration of the impregnation of a platinum-based active phase using the two-phase impregnation method on a support based on silicon carbide (β-SiC) extruded materials.

In a first step, the support based on silicon carbide β-SiC extruded materials is previously impregnated with a distilled water solution with a volume equal to the porous volume of the support, in order to block the entry into pores of the solid. Therefore 5 g of silicon carbide (BET specific surface area 25 m²/g) are initially pre-impregnated with 3 mL of distilled water and are then dried for 5 minutes at 50° C. In a second step, the material is impregnated using the drip method by a solution of platinum bis-acetylacetonate in toluene (apolar solvent), such that the mass of platinum is equal to 2% of the mass of the silicon carbide support (which is equivalent to 0.196 g of acetylacetonate corresponding to 0.100 g of Pt, in 3 mL of toluene). In a third step, the solid obtained is dried under air at ambient temperature and then at 150° C. in a drying oven for 2 hours. It is then calcined in air at 350° C. for 2 hours in order to transform the platinum salt into its corresponding oxide, and is then reduced at 400° C. under a hydrogen flow for 2 hours to form metallic platinum. Metallic platinum Pt is then located outside the silicon carbide pores.

### Example 2

### Use of the Catalyst Obtained by Two-Phase Impregnation

This example illustrates the influence of the impregnation method in the case of total oxidatation of methane into carbon dioxide, namely a purely aqueous method to position the active phase in the pores of the support, and a two-phase method to position the said active phase outside the mesoporosity of the support.

Two catalysts based on metallic palladium supported on silicon carbide pellets (β-SiC, pellet diameter between 0.4 mm and 1 mm, specific surface area 25 m²/g) are prepared such that the mass of metal palladium is equal to 1% of the mass of the silicon carbide support: the purely aqueous impregnation method according to the state of the art is used for one of the two catalysts, while the two-phase impregnation method according to the invention is used for the other.

The purely aqueous impregnation is made by impregnating pellets of silicon carbide (β-SiC) with an aqueous solution of Pd^{II}(NO₃).H₂O. After drying at ambient temperature under air, the solid is placed in the drying oven at 100° C. for 2 hours. The dried solid is then calcined under air at 350° C. for 2 hours in order to form palladium oxide PdO. The metal palladium catalyst supported on silicon carbide is obtained by reduction of its corresponding oxide at 400° C. under hydrogen for 2 hours. This purely aqueous impregnation leads to obtaining the palladium Pd⁽⁰⁾ phase positioned in the porosity of the silicon carbide based support.

The two-phase impregnation of the silicon carbide (β-SiC) support is made by firstly impregnating the support with an aqueous solution with a volume equal to the porous volume of the said support. After drying at 50° C. for 5 minutes, 1% by mass of palladium is then deposited on the support in the form of palladium acetylacetonate (C₁₀H₄O₄Pd) in toluene. The material is then subjected to the same processing as the catalyst prepared by conventional aqueous impregnation. The palladium oxide is then reduced to metallic palladium by heat treatment under hydrogen at 400° C. for 2 hours. Metallic palladium particles are then located outside the silicon carbide pores.

The reaction for total oxidation of methane to carbon dioxide on the two catalysts made using the preparation methods are described above, takes place under the reaction conditions given in Table 1.

TABLE 1
Reaction conditions for the reaction of total oxidation
of methane into carbon dioxide on palladium catalysts
(0) supported on silicon carbide pellets

| | | |
|---|---|---|
| Methane concentration | 1% | volume |
| Methane flow: | 3 | mL/min |
| Oxygen concentration: | 4% | by volume |
| Oxygen flow: | 12.0 | mL/min |
| Helium concentration: | 95% | by volume |
| Helium flow | 285 | mL/min |
| Total flow: | 300 | mL/min |
| Temperature rise gradient (from 20° C. to 700° C.): | 2° | C./min |

| | | | | | | |
|---|---|---|---|---|---|---|
| Catalyst mass used: | 750 | mg | 280 | mg | 56 | mg |
| Catalyst volume used: | 1.2 | mL | 0.45 | mL | 0.09 | mL |
| Gas hourly space velocity: | 15000 | h⁻¹ | 40000 | h⁻¹ | 200000 | h⁻¹ |

The gas hourly space velocity is defined as being the ratio between the total flow and the catalyst volume.

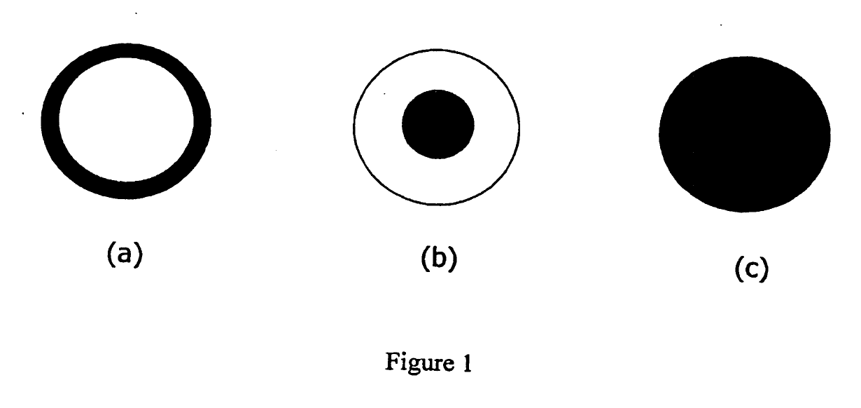

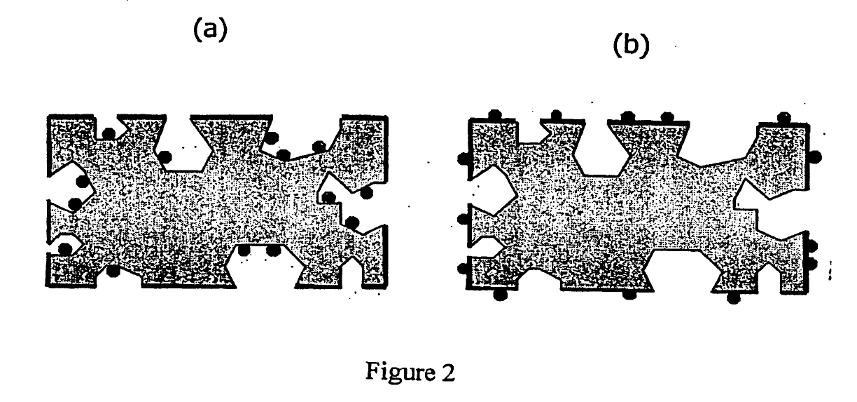

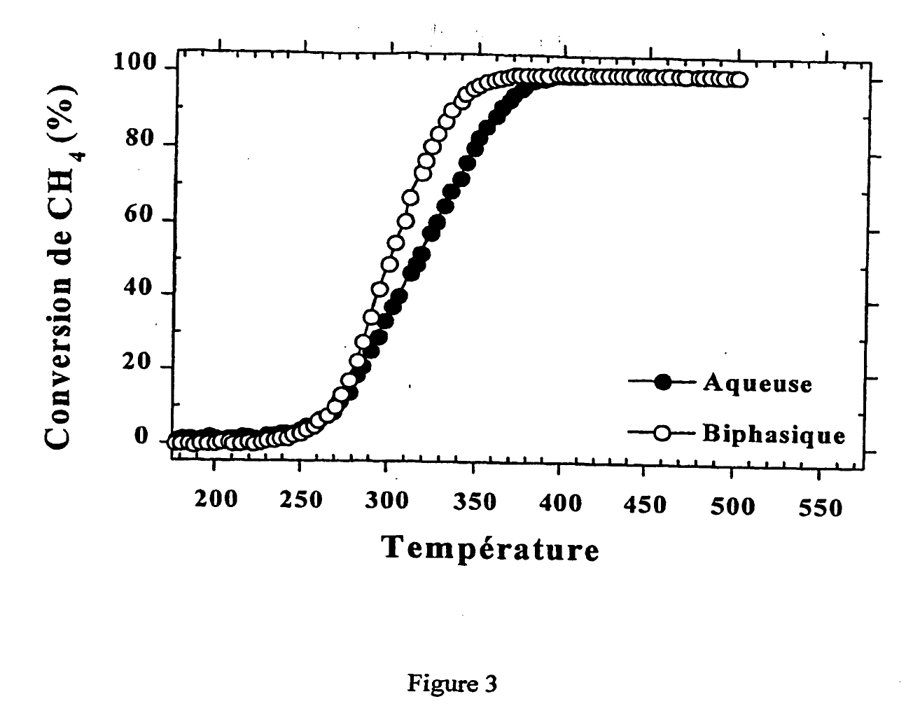

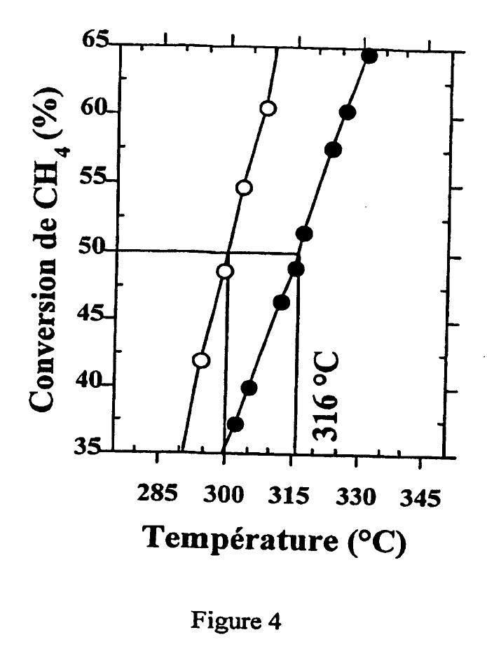

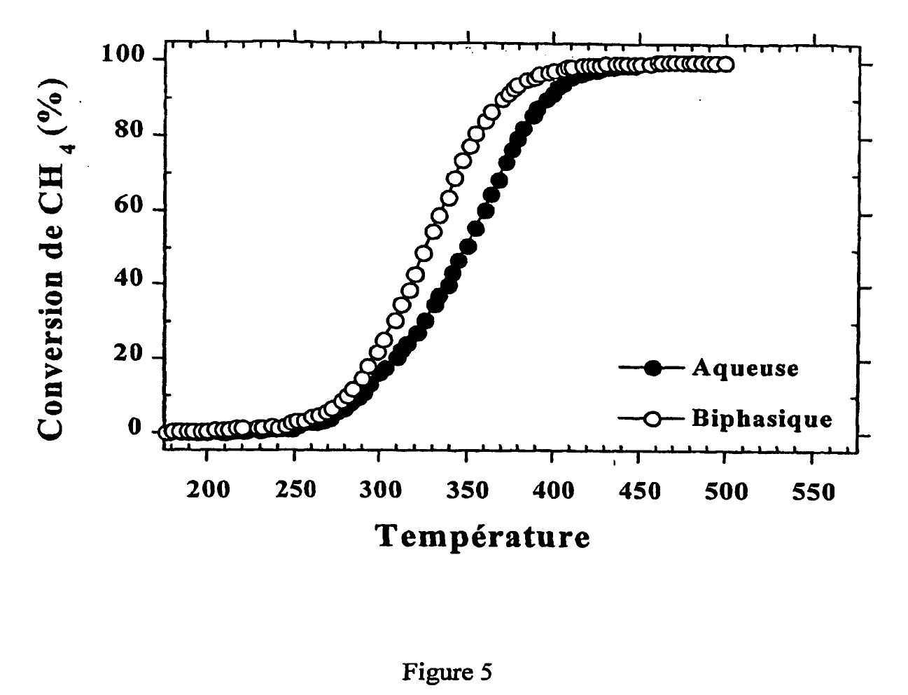

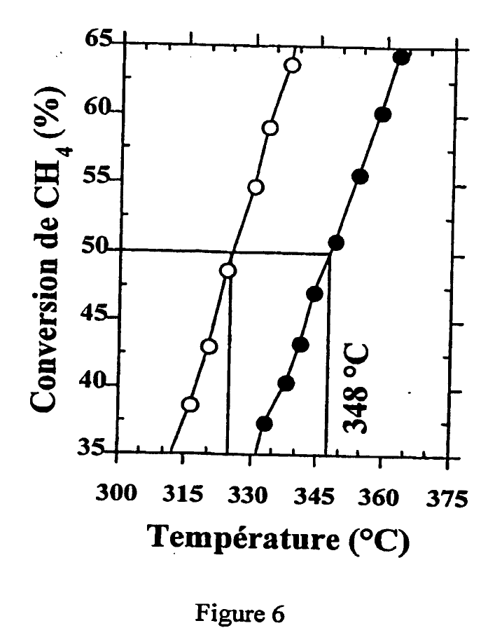

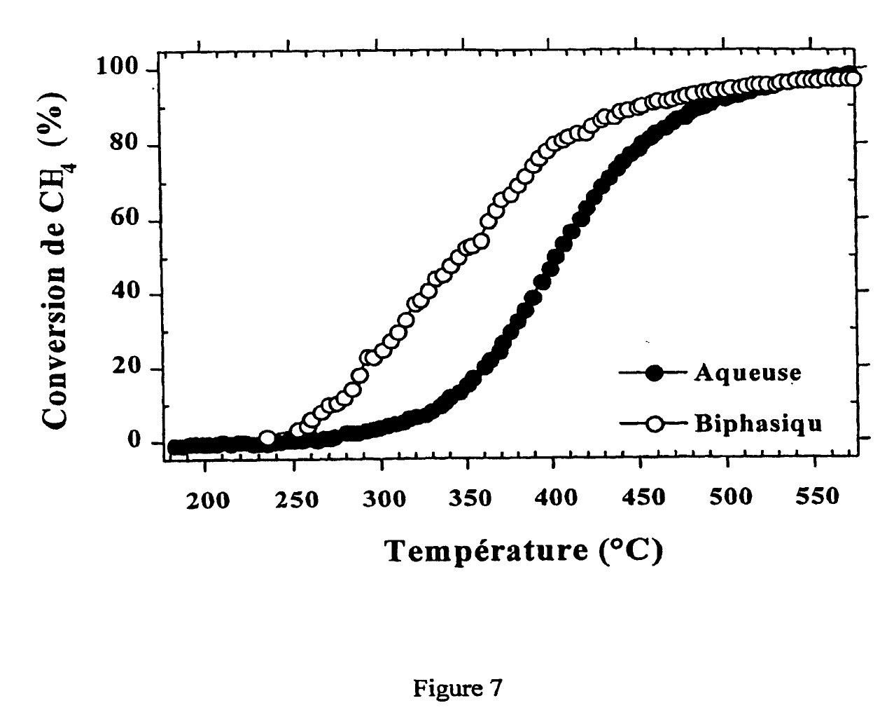

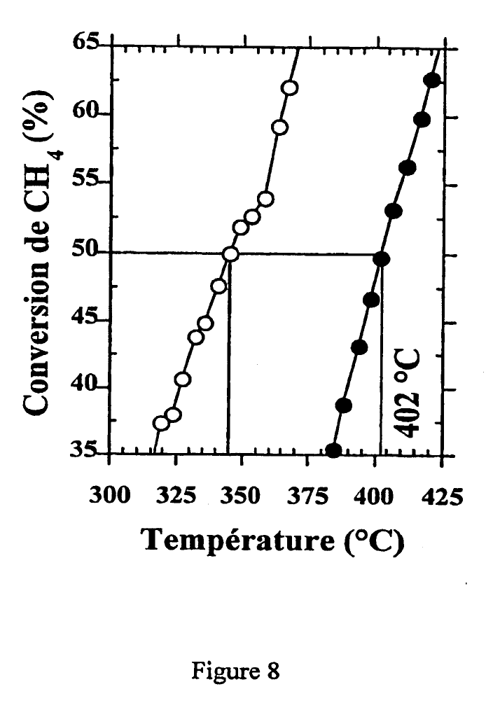

The influence of the impregnation method of the active phase on the catalytic activity for the combustion of methane during preparation of the catalyst is shown in FIG. 3. Table 2 shows half-conversion temperatures obtained on the two catalysts as a function of the gas hourly space velocity of the flow containing 1% and 4% by volume of methane and oxygen respectively. At low gas hourly space velocity (15 000 h⁻¹), the half-conversion temperature on the catalyst prepared by the two-phase impregnation method is 300° C. compared with 316° C. on the catalyst prepared by the conventional impregnation method. This difference is accentuated when the gas hourly space velocity increases, and the temperature difference is 23° C. for a space velocity of 40 000 h⁻¹. This temperature difference reaches 57° C. when the total oxidation of methane is done at a very high gas hourly space velocity, namely 200 000 h⁻¹.

TABLE 2
Half-conversion temperatures obtained using the
catalyst impregnation method as a function of the
gas hourly space velocity of the reaction

| | Half-conversion temperature | | |
|---|---|---|---|
| Gas hourly space | Aqueous | Two-phase | |
| velocity | impregnation | impregnation | Difference |
| 15 000 h⁻¹ | 316° C. | 300° C. | 16° C. |
| 40 000 h⁻¹ | 348° C. | 325° C. | 23° C. |
| 200 000 h⁻¹ | 402° C. | 345° C. | 57° C. |

Note that the catalyst prepared by two-phase impregnation according to the invention has better performance, in other words a significantly lower half-conversion temperature than the catalyst prepared by single-phase aqueous impregnation according to the state of the art. This improved performance of the catalyst according to the invention prepared by two-phase impregnation may be assigned to the presence of palladium on the outer surface of the support; access of palladium, that forms the active phase of the catalyst, to the agent to be transformed is thus better. The position of the active phase outside the porosity of the silicon carbide support thus considerably reduces diffusion phenomena and results in CH₄ conversions higher than those obtained with a catalyst prepared by the conventional purely aqueous impregnation method, at the same temperatures.

### Example 3

### Characterisation of Macropores in an β-SiC Support

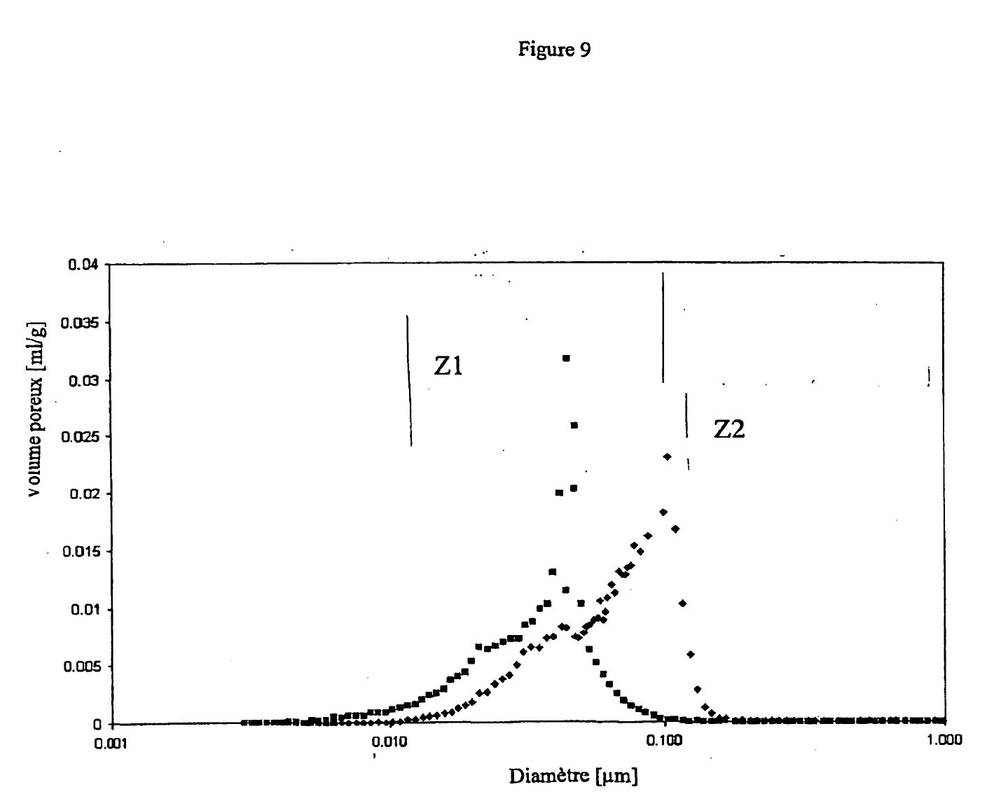

This example shows the distribution of macropores in two β-SiC supports that are quite suitable for implementing the invention, see FIG. 9. These are β-SiC extrudates. Support Z1 was made from Si+C+resin, support Z2 was made with the addition of ethanol. It is found that the distribution of support Z1 is centred at about 0.06 μm, while the distribution of support Z2 is centred at about 0.11 μm.

1. Use of a catalyst for heterogeneous catalysis comprising a β-SiC support and at least one active phase, the said catalyst being obtainable by using a process comprising at least the following steps:
(a) impregnation of the said support having a specific surface area, determined by the BET nitrogen adsorption method at the temperature of liquid nitrogen according to standard NF X 11-621, equal to at least 2 m²/g and comprising at least one active phase precursor, the said impregnation being done by an impregnation process comprising at least a first impregnation step during which the said support is impregnated at least once by a polar agent A, and a second impregnation step during which the said support is impregnated at least once by an agent B less polar than agent A, knowing that at least agent B comprises at least one active phase precursor,
(b) thermal breakdown of the said precursor,
the said use being as a catalyst for chemical reactions selected among oxidation of methane or other hydrocarbons, oxidation of carbon monoxide, or as a catalyst for depollution of exhaust gases of vehicles with internal combustion engines.

2. Use according to claim 1, characterised in that the said active phase precursor is a metallic compound.

3. Use according to claim 2, characterised in that the metal contained in the said metallic compound of agent A and/or agent B is selected among the group composed of the Fe, Ni, Co, Cu, Pt, Pd, Rh, Ru, Ir elements.

4. Use according to claim 2 or 3, characterised in that the said metallic compound contained in the said agents is either a salt solved in a solvent, or an organo-metallic compound.

5. Use according to claim 4, characterised in that the said organo-metallic compound is either dissolved in a solvent, or used in its pure state.

6. Use according to any one of claims 1 to 5, characterised in that the said support is in the form of balls, fibres, tubes, filaments, felt, extruded materials, foams, monoliths or pellets.

7. Use according to any one of claims 1 to 6, characterised in that the said support has a BET specific surface area more than 2 m²/g, preferably more than 10 m²/g, and even better, more than 20 m²/g.

8. Use according to any one of claims 1 to 7, characterised in that the said support has a BET specific surface area between 1 and 100 m²/g.

9. Use according to any one of claims 1 to 8, characterised in that the said support comprises macropores with a size between 0.05 and 10 μm, and optionally also mesopores with a size between 4 and 40 nm.

10. Use according to claim 9, characterised in that the said macropores have a size between 0.05 and 1 μm.

11. Use according to one of claims 1 to 10, characterised in that the maximum size distribution of the said macropores is between 0.06 and 0.4 μm, and preferably between 0.06 and 0.2 μm.

12. Use according to any one of claims 1 to 11, characterised in that the impregnation method (a) comprises also at least one drying step after the first and/or the second impregnation step.

13. Use according to any one of claims 1 to 12, characterised in that the impregnation method (a) comprises also at least a preliminary treatment of the support that introduces hydrophobic and/or hydrophilic functions on the surface of the said support.

14. Use according to any one of claims 1 to 13, characterised in that the said precursor at least partially forms a metallic oxide during its thermal breakdown.

15. Use according to claim 14, characterised in that the thermal breakdown of the said precursor is followed by a treatment under a reactive gas.

16. Use according to claim 14 or 15, characterised in that the said treatment under a reactive gas is a reduction treatment.

17. Use according to claim 16, characterised in that the said reduction treatment has been carried out in an atmosphere containing hydrogen H₂.

18. Use according to one of claims 1 to 17, characterised in that the support, which has been dried after the last impregnation step, is calcined under air at a temperature between 200° C. and 500° C., and preferably between 300° C. and 400° C.

19. Method of impregnation of a β-SiC support with a specific surface area, determined by the BET nitrogen adsorption method at the temperature of liquid nitrogen according to standard NF X 11-621, equal to at least 1 m²/g and comprising macropores with a size between 0.05 and 10 μm, and optionally also mesopores with a size between 4 and 40 nm, the said process comprising at least the following steps:
(a) a first impregnation step during which the said support is impregnated at least once by a polar agent A,
(b) a second impregnation step during which the said support is impregnated at least once by an agent B less polar than agent A,
and in which process at least one agent B among the said agents A and B comprises at least one active phase precursor.

20. Method according to claim 19, characterised in that the said support has a specific surface area equal to at least 10 m²/g.

21. Method according to claim 20, characterised in that the average size of the said macropores of the said support is between 0.05 and 1 μm.

22. Method according to claims 19 to 21, characterised in that the maximum value in the distribution of the said macropores by size is between 0.06 and 0.4 μm, and preferably between 0.06 and 0.2 μm.

23. Product that can be obtained using the method according one of claims 19 to 22.
